(19) United States
(12) Patent Application Publication
(10) Pub. No.: US 2008/0036178 A1
(43) Pub. Date: Feb. 14, 2008

(54) Vehicular towing hitch

(76) Inventors: Clarence Slaubaugh, Marshallville, OH (US); Larry Chimento, Marshallville, OH (US)

Correspondence Address: PEARNE & GORDON LLP, 1801 EAST 9TH STREET, SUITE 1200, CLEVELAND, OH, 44114-3108, US

(21) Appl. No.: 11/788,885

(22) Filed: Apr. 23, 2007

Related U.S. Application Data
(60) Provisional application No. 60/793,944, filed on Apr. 21, 2006.

(51) Int. Cl. B60D 1/00; B60D 1/06; B60D 1/40

(52) U.S. Cl. 280/479.2; 280/504; 280/511

(57) ABSTRACT

A hitch is disclosed for towing a trailer behind a vehicle. The hitch includes a base member to be coupled to the vehicle and a first arm coupled to the base and comprising a female receptor adjacent to a distal end thereof for receiving a first male connector of the trailer to couple the trailer to the vehicle. A second arm is also coupled to the base and includes a female receptor adjacent to a distal end thereof for receiving a second male connector of the trailer to couple the trailer to the vehicle, wherein a lateral distance between the female receptor provided to the first arm and the female receptor provided to the second arm is selectively adjustable.

### CROSS-REFERENCE TO RELATED APPLICATIONS

This application claims the benefit of U.S. Provisional Application No. 60/793,944, filed on Apr. 21, 2006 entitled Vehicular Towing Hitch.

### BACKGROUND OF THE INVENTION

1. Field of the Invention

The present invention is directed generally to a towing hitch, and more particularly to a towing hitch for coupling a farm implement having a three-point interface to a truck licensed for operation on public roadways.

2. Description of Related Art

Agricultural implements such as plows, hay balers, spreaders, mowers and other such trailers are towed behind an agricultural tractor 8 while in use. The connection between the trailer and the agricultural tractor 8 is facilitated with what is commonly referred to as a three-point hitch 2, which is shown in FIG. 1. As shown, the three-point hitch 2 includes a pair of lift arms 4 that are each independently pivotally coupled to a tail section 6 of the agricultural tractor 8 at a proximate end 7 of the lift arms 4. A connecting arm 11 is used to secure each of the lift arms 4 to an adjustable boom 17 having an elevation that can be adjusted by the agricultural tractor's hydraulic system. A bracket 21 formed at the tail section 6 of the agricultural tractor 8 includes a pin 23 that extends between a pair of braces 15 to receive a draw bar that is also coupled to the trailer being towed by the agricultural tractor 8 to minimize the likelihood of a rear rollover of the agricultural tractor 8.

Agricultural trailers that are to be towed behind agricultural tractors 8 include a pair of laterally extending pins 3, shown in FIG. 2, that typically extend outwardly from the trailer to facilitate attachment of the trailer to the three-point hitch 2 of the agricultural tractor 8. Each pin 3 is separated from the other by a fixed distance X, a distance X that can vary from trailer to trailer. To allow agricultural tractor 8 to tow a variety of different trailers having different distances X between the lateral pins 3 of the trailer, the lift arms 4 of the agricultural tractor 8 are pivotally connected to the agricultural tractor 8 so the lift arms 4 can travel in a plane generally parallel to the ground on which the agricultural tractor 8 rests, as indicated by the arrow 9 in FIG. 1. Thus, to hitch a trailer to the agricultural tractor 8, the lift arms 4 are spread sufficiently apart and then placed over the pins 3 of the trailer. The lift arms 4 are then drawn towards each other a short distance so each pin 3 extends through a receiver 35 provided at the distal end 5 of the lift arms 4. A locking pin serves to prevent the lift arms 4 from sliding off of the trailer pins 3, thereby causing the trailer to become disconnected from the agricultural tractor 8 when such disconnection is not desired. A chain 3 between the lift arms 4 and the agricultural tractor 8 limits the lateral travel of each lift arm 4 parallel to the ground along arrow 9 to prevent contact between the lift arms 4 and the tires of the agricultural tractor 8, while still allowing the trailer to pivot with respect to the agricultural tractor 8 such as when the agricultural tractor 8 turns.

However, farmers are often required to transport an agricultural trailer such as those mentioned above to a remote field located far away from the location where said trailer is stored. Further, agricultural trailers are subjected to harsh environments, and require regular maintenance to function properly, particularly at the beginning and end of each crop cycle when the trailer is removed from and returned to storage. Towing the agricultural trailer behind an agricultural tractor 8 to a remote field or a distant maintenance facility can be very time consuming due to the slow top speed of agricultural tractors 8, which are not designed or licensed for passenger transportation. While some maintenance facilities offer to transport the agricultural trailer and take it to the remote field or into the distant maintenance facility, such a service is expensive due again to the time required for such transportation with an agricultural tractor 8.

Accordingly, there is a need in the art for a trailer hitch to couple an agricultural trailer equipped with an interface for a three-point hitch to a vehicle other than an agricultural tractor for transporting the agricultural trailer over public roadways. The trailer hitch should accommodate trailers having three-point interfaces within a range of dimensions, and should be interchangeable with conventional hitches for towing traditional trailers over the public roadways.

### BRIEF SUMMARY OF THE INVENTION

According to one aspect, the present invention provided a hitch for towing a trailer behind a vehicle licensed to navigate public roadways. The hitch includes a base member to be coupled to the vehicle and a first arm coupled to the base and comprising a female receptor adjacent to a distal end thereof for receiving a first male connector of the trailer to couple the trailer to the vehicle. A second arm is coupled to the base and includes a female receptor adjacent to a distal end thereof for receiving a second male connector of the trailer to couple the trailer to the vehicle, wherein a lateral distance between the female receptor provided to the first arm and the female receptor provided to the second arm is selectively adjustable.

According to another aspect, the present invention provides a hitch for towing a trailer behind a vehicle licensed to navigate public roadways. The hitch comprises a base member to be coupled adjacent to a tail section of the vehicle and a first support member coupled to the base member and extending outwardly in a direction generally away from the base member. A first connector is provided adjacent to a distal end of the support member that is cooperable with a first trailer connector to establish a linkage between the first connector and the first trailer connector. Similarly, a second support member is coupled to the base member and extending outwardly in a direction generally away from the base member, and a second connector provided adjacent to a distal end of the second support member that is cooperable with a second trailer connector to establish a linkage between the second connector and the second trailer connector.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a three-point hitch installed adjacent to a tail section of an agricultural tractor;

FIG. 2 is a perspective view of a portion of a trailer/agricultural implement to be releasably coupled to an agricultural tractor by a three-point hitch;

FIG. 3a is a top view of a trailer connector provided with a plurality of male extensions in accordance with an aspect of the invention, wherein a lateral distance between connectors is fixed;

FIG. 3b is a top view of a hitch in accordance with an aspect of the invention, wherein a lateral distance between connectors is fixed;

FIG. 3c is a cross-sectional view of a base member taken along line 3c-3c in FIG. 3b;

FIG. 4a is a top view of a hitch in accordance with an aspect of the invention, wherein a portion of a support member is adjustable to permit adjustment of a lateral distance between connectors;

FIG. 4b is a perspective view of a Gimbal or ball-in-socket connector provided adjacent to distal ends of a support member in accordance with an embodiment of the present invention;

FIG. 4c is a cross-sectional view of the Gimbal or ball-in-socket connector shown in FIG. 4b taken along line 4c-4c;

FIG. 5 is a top view of a hitch in accordance with an aspect of the invention, wherein both portions of a support member are adjustable to permit adjustment of a lateral distance between connectors;

FIG. 6 is a top view of a hitch in accordance with an aspect of the invention, wherein both lateral arms forming a support member are pivotally adjustable to permit adjustment of a lateral distance between connectors;

FIG. 7 is a perspective view of a hitch in accordance with an aspect of the invention positioned adjacent to a tail section of a vehicle licensed to navigate public roadways;

FIG. 8 is a top view of a hitch including a step in accordance with an aspect of the invention, wherein a portion of a support member is adjustable to permit adjustment of a lateral distance between connectors;

FIG. 9 is a perspective and partially exploded view of a hitch including a plate connector adjacent to each distal end of the support member in accordance with an embodiment of the present invention;

FIG. 10 is a perspective and partially exploded view of a hitch including a quick-hitch connector adjacent to each distal end of the support member in accordance with an embodiment of the present invention; and

FIG. 11 is a perspective and partially exploded view of a hitch including a quick-hitch connector provided adjacent to each distal end of the support member in accordance with an embodiment of the present invention, wherein the lateral distance separating the quick-hitch connectors is adjustable.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

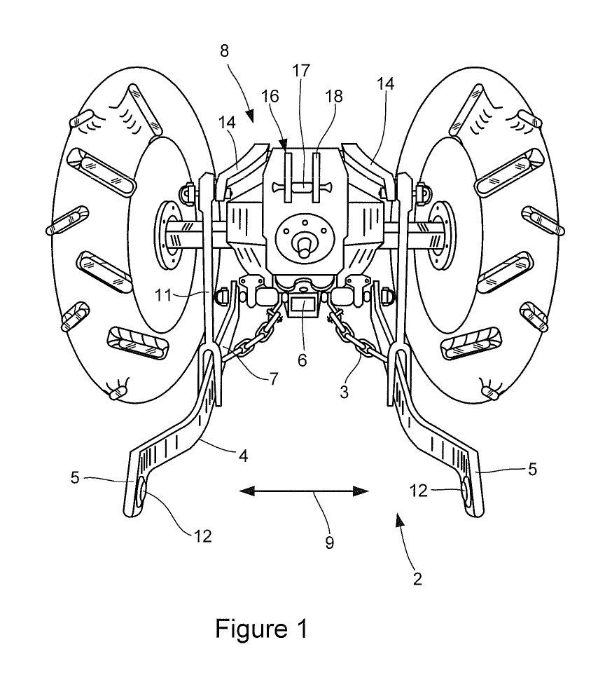

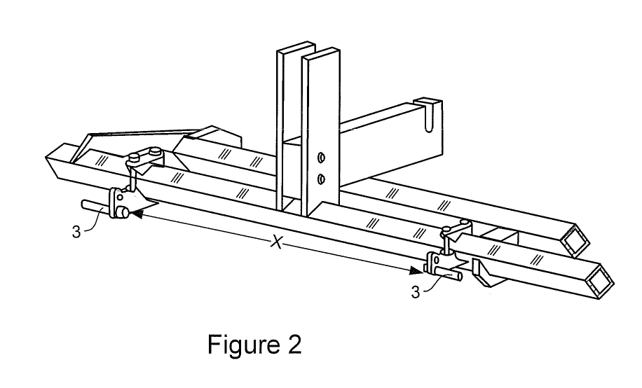

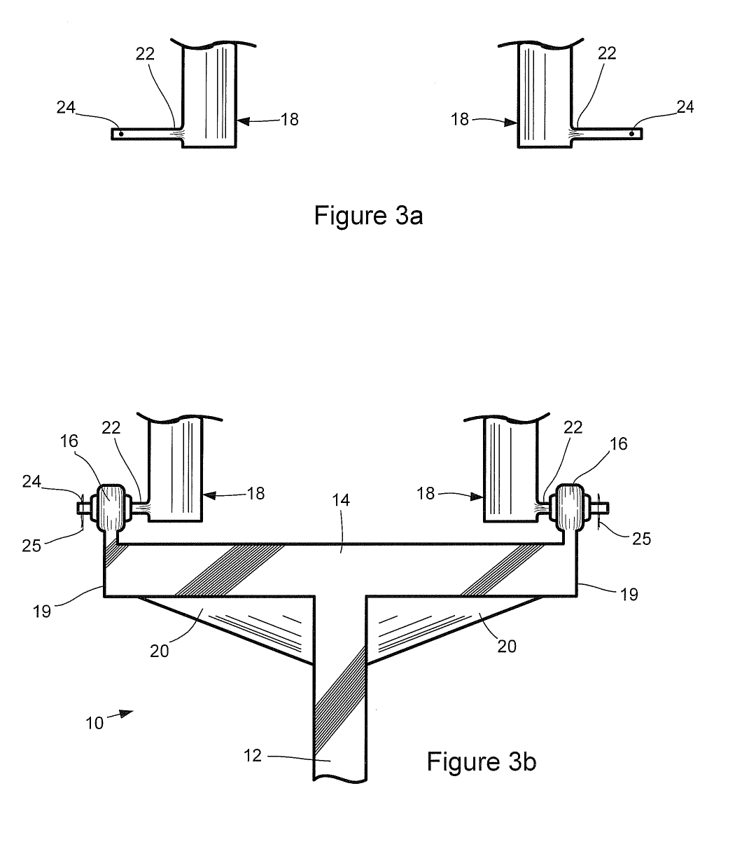

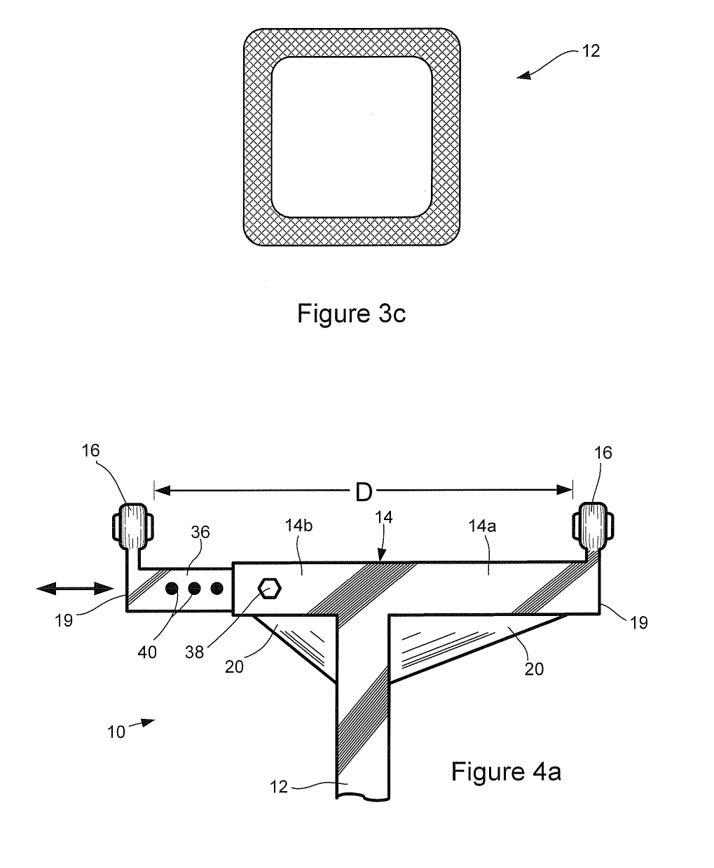

A hitch 10 for towing an agricultural implement such as a plow, hay baler, spreader, mower and other such trailers having a feature for establishing a three-point connection with a towing vehicle licensed to navigate public roadways is shown in FIG. 3b. Such an agricultural implement is referred to herein interchangeably as an implement and a trailer, but regardless of the terminology, the agricultural trailer includes a connector 18 such as that shown in FIG. 3a, that also facilitates connection of the agricultural trailer to a hitch provided to an agricultural tractor 8 such as that shown in FIG. 1.

The connector 18 shown in FIG. 3a of the agricultural trailer includes a pair of laterally extending male extensions 22 that typically extend outwardly, away from the connectors 18 of the trailer to facilitate attachment of the trailer to the three-point hitch 2 of the agricultural tractor 8. Each male extension 22 is separated from the other by a fixed distance X, a distance X that can vary from trailer to trailer. An aperture 24 is formed in each male extension 22 through which a locking pin 25 can be extended to minimize the likelihood that the male extensions 22 can be inadvertently removed from the trailer hitch 10 once coupled thereto as described in detail below. The locking pin 25 or other such device interferes with the removal of the male extension 22 from the connectors 16 once the linkage between the two is established. As shown in FIG. 3b, the male extension 22 extends through an aperture formed in the female connectors 16 supported by the support member 14. Once an extension 22 is inserted through each connector 16, the locking pin 25 can be inserted to extend through the aperture formed in the male extension 22 on an opposite side of the connector 16 relative to the trailer connector 18. The locking pin 25 inserted through the aperture 24 of the male extension interferes with the removal of the extension 22 from each connector 16.

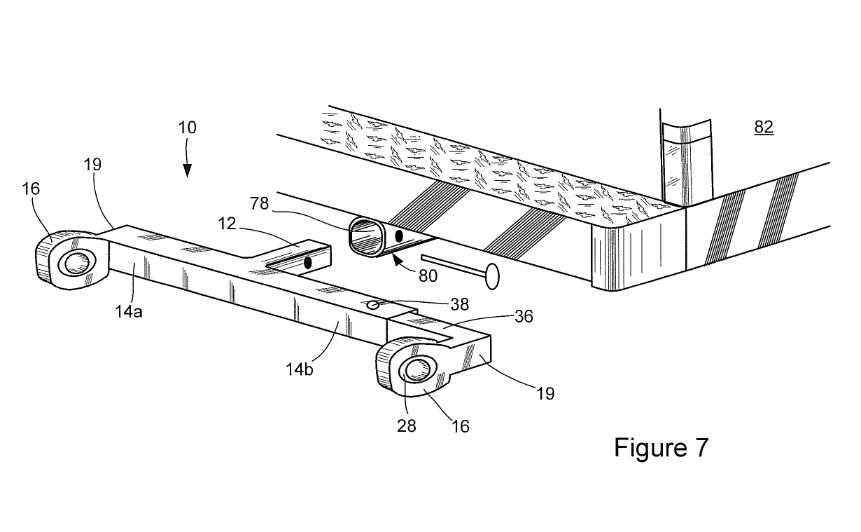

Examples of a vehicle 82 (FIG. 7) licensed to navigate public roadways to which the hitch 10 can couple the agricultural trailer include, but are not limited to passenger vehicles such as pickup trucks, sport utility vehicles, long-haul tractors, and the like. These vehicles are contrasted with the typical agricultural tractor 8, such as that illustrated in FIG. 1, in that they are typically licensed to navigate public roadways, are commonly used as modes of passenger transportation in everyday life, and have a faster top speed than the conventional agricultural tractor 8. Further, the vehicles 82 to which the hitch 10 of the present invention can be coupled each lack a dedicated, permanently-fixed, conventional three-point hitch such as that provided to the tail section 6 of the agricultural tractor 8 in FIG. 1. However, the hitch 10 can be compatible with an existing tow package provided to the vehicle 82 such as a receiver marketed under the trade name Hidden Hitch®. Thus, the terminology “vehicles licensed to navigate public roadways” or “vehicle” is used herein to refer to motorized vehicles 82 other than agricultural tractors 8.

As shown in FIG. 3b, the hitch 10 includes a base member 12 to be coupled adjacent to a tail section of the vehicle 82 for securing the hitch 10 to the vehicle. The base member 12 is shown as an elongated, hollow shank 12 having a generally rectangular cross-section that can be at least partially inserted into a hollow cavity 78 of a receiver 80 secured to the underside of the vehicle as shown in FIG. 7. The receiver 80 can be secured adjacent to a tail section of the vehicle 82 to a rigid, structural, load-withstanding member of the vehicle's frame that can withstand the forces imparted on the vehicle 82 by the agricultural trailer while towing such a trailer. An example of a suitable receiver 80 for securing the hitch 10 to the vehicle is that marketed under the trade name Hidden Hitch® Class V Magnum Hitch Receiver by Algonquin Industries International, Inc. The Class V Magnum Hitch Receiver is but one illustrative example, and assemblies including a receiver 80 in combination with a hitch 10 rated in any classification or category is within the scope of the present invention, including but not limited to: class I assemblies having a rated gross trailer weight of up to 2,000 pounds and a tongue weight of up to 200 pounds; class II assemblies having a rated gross trailer weight of up to 3,500 pounds and a tongue weight of up to 300 pounds; class III assemblies having a rated gross trailer weight of up to 5,000 pounds and a tongue weight of up to 500 pounds; class IV assemblies having a rated gross trailer weight of up to 10,000 pounds and a tongue weight of up to 1,200 pounds; and class V assemblies having a rated gross trailer weight of up to 16,000 pounds and a tongue weight in excess of 1,200 pounds; and so on.

A cross sectional view of the base member 12 is shown in FIG. 3c. As shown, the shank 12 has a generally rectangular cross section with rounded corners to approximate the interior dimensions of the hollow cavity 78 formed by the receiver 80. The close relationship between the dimensions of the shank 12 and the hollow cavity 78 minimize lateral and vertical movement of the shank 12 within the cavity 78. The shank 12, like other members of the hitch 10, can optionally be fabricated from ¼ inch steel, a steel alloy, or any other suitably strong material to withstand forces imparted thereon when coupling an agricultural trailer to a vehicle 82.

A support member 14, also referred to and described herein as one or more arms 14, is coupled to the shank 12 such that it extends outwardly in opposite directions generally away from the shank 12. The support member 14 can be a single metallic extension as shown in FIG. 3b, having a generally rectangular cross section and extending in opposite directions generally away from, and transverse to the shank 12, with the shank 12 being substantially centered between distal ends 19 of the support member 14. The support member 14 can be formed from a plurality of individual arm segments 14a, 14b that both extend generally away from the shank 12, in opposite directions or merely in different directions as shown in FIG. 6 and discussed below. The arm 14 can optionally be integrally formed with the shank 12 according to other embodiments, sharing the generally-rectangular cross-sectional shape.

Regardless of configuration, the support member 14 supports a connector 16 adjacent to each distal end 19 thereof that is cooperable with the male extension 22 extending from the connector 18 provided to the trailer to be towed to establish linkages between the hitch 10 and the trailer. The connector 18 provided to the trailer to be towed will be referred to from this point on as a “trailer connector 18.” For embodiments where the support member 14 is formed from a plurality of arms 14a, 14b, a connector 16 is provided adjacent to a distal end 19 of each arm. A gusset 20 or other type of brace can optionally be installed to extend between the shank 12 and support member 14 to reinforce the support member 14, thereby maximizing the towing capacity of the hitch 10.

The connectors 16 supported by the support member 14 in FIG. 3b are spaced a fixed lateral distance apart to cooperate with trailer connectors 18 having a similar spacing, such as the case where the hitch 10 is permanently attached to the agricultural trailer, or the position of at least one of the trailer connectors 18 is adjustable. Embodiments of the connector 16 provided adjacent the distal ends 19 of the support member 14 discussed herein can be independently selected from a female receptor such as a plate 116 (FIG. 9) with an aperture 118 formed therein, a ball-in-socket connector commonly referred to as a Gimbal, and the like; and a male member such as a pin that is to extend through a female trailer connector 18, and the like. In any event, the trailer-connector sex is to be the opposite of that of the connector 16 provided to the hitch 10 to facilitate cooperation and the formation of linkages therebetween. Regardless of the sex of each of the connectors 16 and the trailer connectors 18, each connector 16 is compatible with its respective trailer connector 18 to form a linkage therebetween.

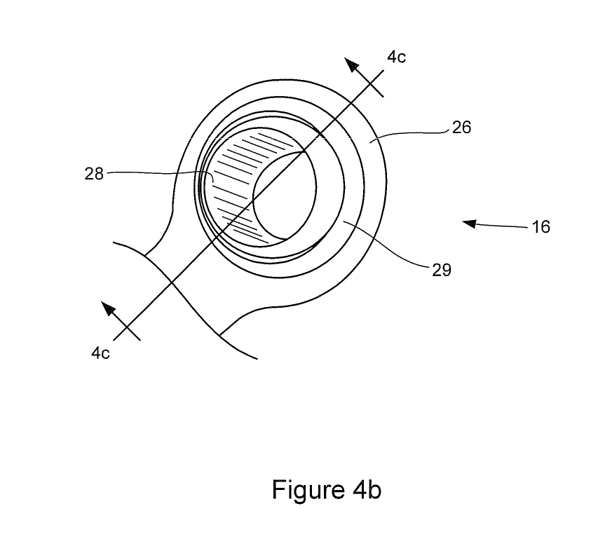

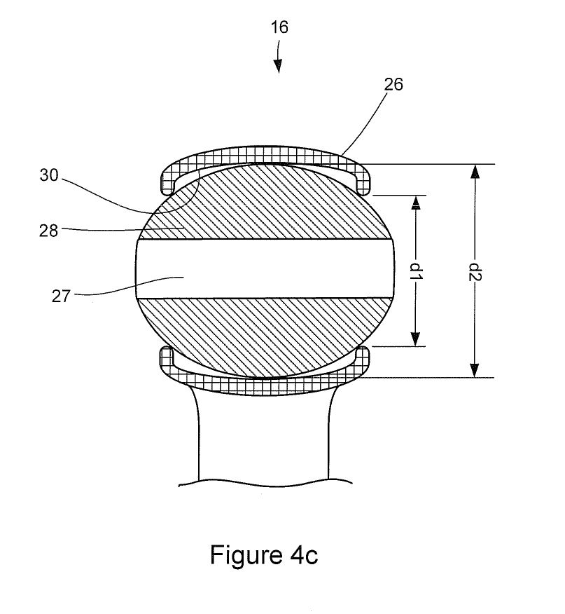

An embodiment of the ball-in-socket connector 16, also referred to herein as the Gimbal 16, mentioned above is shown in FIG. 4b. The ball-in-socket connector 16 includes a metal frame 26 defining a socket in which a metallic ball 28 is to be at least partially enclosed. The socket defined by the frame 26 has a generally-round aperture 29 on opposite lateral sides thereof. Such a shape can be described as a hollow metal sphere with two of its lateral sides truncated, or cutaway. Thus, a cross-sectional shape of the socket taken along line 4c-4c, said cross-section being shown in FIG. 4c, includes an arcuate portion 30 defining the peripheral boundary of the socket for receiving the ball 28 therein. The diameter d1 of the aperture 29 located at each lateral side of the ball-in-socket connector 16 is less than the largest diameter d2 between opposing arcuate portions 30 of the frame 26. Due to this difference between diameters d1, d2, the ball 28 can pivot within the socket, but can not escape through the aperture 29 formed at either side of the Gimbal 16.

The ball 28 received in the socket is a generally-spherical metal ball 28 having a diameter that is approximately the same as, but slightly less than the largest interior diameter d2 of the socket measured between the arcuate portions 30 of the Gimbal 16. The diameter of the ball 28, however, is larger than the diameter of the aperture 29 formed in each lateral side of the ball-in-socket connector 16 to prevent removal of the ball 28 through said apertures 29. A generally-cylindrical passage extends entirely through the ball 28, forming an internal passage 27 through the ball 28. The male extension 22 of the trailer connector 18 is inserted into, and extends through the internal passage, and is prevented from being removed.

To form the ball-in-socket connector 16, the ball 28 can be inserted through one aperture 29 in a lateral side of the frame 26 to be at least partially surrounded by the arcuate portions 30 of the socket. With the ball 28 resting in the socket, a metallic ring can be threadedly fastened, welded, or otherwise secured adjacent to the aperture 29 through which the ball 28 was inserted into the socket to limit the diameter d1 of the aperture. The ring restricts the size of the aperture 29 to a size suitable to prevent passage of the ball 28 there through. For example, the ring can reduce the diameter of the aperture 29 through which the ball 28 was inserted to a diameter d1 that is less than the outside diameter of the ball 28. Installed in this manner, the ball 28 can rotate at least partially around a plurality of axes within the socket without being removed from the socket.

Another embodiment of securing a ball 28 within a socket is to insert a suitably-sized ball 28 that can pass through at least one aperture 29 of the socket in a first orientation, but can't pass through the aperture 29 in a second orientation. Yet other embodiments include a ball 28 integrally formed within the socket such that the socket is formed as a single unit through laser etching; a socket formed from a plurality of components combined around the ball 28; and the like. But regardless of the method employed to secure the ball 28 within the socket, the ball 28 can rotate to accommodate movement of the trailer connector 18 while linked to the hitch 10 with the ball-in-socket connector 16.

Other embodiments can optionally include a connector 16 other than a ball-in-socket connector 16 provided to the distal ends 19 of the one or more arms forming the support member 14. An example of such an alternate connector 16 includes a metal plate 116 with an aperture 118 formed therein, as shown in the embodiment appearing in FIG. 9. A catch arm 120 extends rearward, generally in the direction of the trailer to be coupled to the vehicle 82 with the hitch 10. A recess 122 is formed in the catch arm 120 for receiving the male extension 22 of the trailer connector 18. When the male extension 22 is disposed within the recess 122, the aperture 118 in the plate 116 can be aligned with the male extension 22 and the plate 116 slid over the male extension 22 and placed adjacent to the catch arm 120. The plate 116 is also oriented such that two threaded alignment pins 124 projecting outwardly from the catch arm 120 extend through apertures 126 formed in the plate 116 when the plate 116 is disposed adjacent to the catch arm 120. A threaded fastener 128 such as a hexagonal bolt is threadedly secured to each alignment pin 124, thereby maintaining the plate 116 in a position adjacent to the catch arm 120 and securing the male extension 22 of the trailer connector 18 within the recess 122. Although the Gimbal 16 and the plate 116 have been discussed in detail, it is to be noted that the present invention includes various other embodiments of the connector that can be provided to the distal ends 19 of the one or more support members 14 to selectively secure the trailer to the hitch 10.

FIG. 4a shows an alternate embodiment of the hitch 10, wherein a lateral distance D between the connector 16 provided adjacent to each distal end 19 of the support member 14 is adjustable. As shown, one laterally-extending portion 14a of the support member 14 has a fixed length and includes a connector 16 compatible with a trailer connector 18 provided adjacent to a distal end 19 thereof. This connector 16 is separated a fixed lateral distance from the shank 12. Just as before, the connector 16 can optionally be a ball-in-socket connector 16, and a gusset 20 can optionally be installed between this portion of the support member 14 and the shank 12 to which it is coupled to maximize the strength and towing capacity of the hitch 10.

The portion of the support member 14b allowing lateral adjustment of the connector 16 includes a hollow arm 14b defining a travel path along which a telescopically-extendable inner segment 36 shown in FIG. 4a can travel. The inner segment 36 supports a connector 16 at a distal end 19 thereof and can be telescopically extended from, or inserted into the stationary segment 14b of the support member 14 to extend or reduce the lateral distance D between the connector 16 provided adjacent to each distal end 19, respectively. A locking pin 38 can extend at least partially through the stationary portion 14b of the support member 14 to interfere with the removal or insertion of the inner segment 36 relative to the stationary segment 14b. According to one embodiment, the inner segment 36 is provided with a plurality of adjustment apertures 40 formed therein for receiving the locking pin 38 extending at least partially through the stationary segment 14b of the support member 14. And just as before, a gusset 20 or other brace can optionally be installed between the stationary segment 14b and the shank 12 to strengthen the hitch 10 and maximize its towing capacity.

The locking pin 38 can optionally be spring biased into the stationary segment 14b so the length of the adjustable portion of the support member 14 is normally locked. When adjustment of the lateral distance D between the connectors 16 is desired, the locking pin 38 can be manually pulled outwardly away from the stationary segment 14b of the support member 14 such that communication between the locking pin 38 and the inner segment 36 is discontinued. The desired lateral distance D adjustment is performed by extending the desired length of the inner segment 36 from, or inserting the desired length of the inner segment 36 into the stationary segment 14b. The aperture 40 in the inner segment 36 that is closest to the desired adjustment is aligned with the locking pin 38 of the stationary segment 14b, and the locking pin 38 released. Once the locking pin 38 is released, the biasing force of the spring urges the locking pin 38 inward to reestablish communication with the inner segment 36 and prevent lateral movement of the inner segment 36 relative to the stationary segment 14b.

Alternate embodiments of the present invention can include a threaded locking pin 38 instead of a spring-biased locking pin 38. According to these alternate embodiments, the locking pin 38 can take the form of a bolt, a screw, or any other threaded fastener. The position of the locking pin 38 relative to the inner segment 36 can be accomplished by rotating the locking pin 38 clockwise and counterclockwise to insert and retract the locking pin 38 relative to the inner segment 36, respectively. Rotating the locking pin 38 causes an inward surface of the locking pin 38 to contact an external surface of the inner segment 36 within the stationary portion 14b of the support member. Communication between cooperable threaded portions provided to the locking pin 38 and the stationary segment 14b facilitate the insertion and removal of the locking pin 38 from the stationary portion 14b of the support member 14. The threaded locking pin 38 can be threadedly inserted into, and removed from the stationary portion 14b of the support member 14 with the inner segment 36 in any position relative to the stationary portion 14b to establish the desired lateral distance D between the connectors 16. Because of this flexibility in inserting and removing the threaded locking pin 38, the inner segment 36 can be infinitely adjusted relative to the stationary portion 14b, instead of between discrete, predetermined adjustment apertures.

Although the spring-biased and threaded locking pins 38 have been described above, it should be noted that the locking pin 38 can be independent of the stationary segment 14b. For instance, the locking pin 38 can be a free pin that can be completely removed and inserted into the stationary segment 14b as desired to facilitate and prevent adjustment of the distance D, respectively.

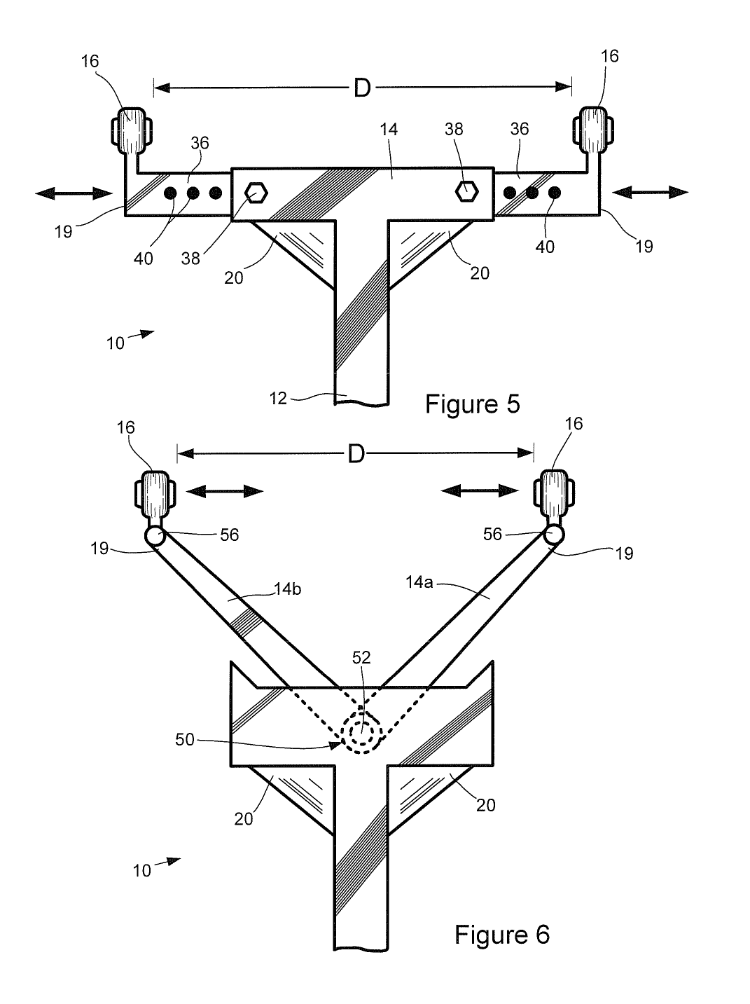

FIG. 5 schematically illustrates another embodiment including two laterally-adjustable portions of the support member 14 that can be manipulated to vary the lateral distance between connectors 16 provided to distal ends 19 thereof. As shown, each laterally-adjustable portion includes an arm with a telescopically-extendable inner segment 36 that is telescopically extendable from within stationary segments 14a, 14b of the support member. Each inner segment 36 supports a connector 16 at a distal end 19 thereof and can be telescopically extended from, or inserted into its respective stationary segment 14a, 14b of the support member 14 to extend or reduce the lateral distance D between the connectors 16, respectively. Analogous to other embodiments disclosed herein, a locking pin 38 can extend at least partially through the stationary segments 14a, 14b of the support member 14 to interfere with the removal from, and the insertion of the inner segments 36 into their respective stationary segments 14a, 14b. Each inner segment 36 can be provided with a plurality of adjustment apertures 40 formed therein for receiving the locking pin 38 extending at least partially through the stationary segments 14a, 14b of the support member 14. A gusset 20 or other brace can optionally be installed between the stationary segments 14a, 14b and the shank 12 to strengthen the hitch 10 and maximize its towing capacity.

Although the telescopically-extendable portions of the support member 14 described above include an inner segment 36 that can be extend from, and inserted into a stationary segment, the present invention is not so limited. Instead, the present invention also includes telescopically extendable segments including an outer member that can be telescopically adjusted over the stationary segment. Further, the adjustable portion of the support member 14 is not necessarily limited to being telescopically adjustable. Other embodiments include translatable segments, infinitely adjustable segments, and other adjustable segments of the support member 14 that can be repositioned as desired to vary the lateral distance between the connectors 16 provided at the distal ends 19 of the support member 14. Yet other embodiments include: a track formed along the support member 14 in which at least one of the connectors 16 can be independently adjusted relative to the other to vary the lateral distance therebetween; a plurality of receivers distributed along the support member 14 for selectively coupling at least one of the connectors 16 at desired positions to the support member 14; and the like.

Use of an embodiment of the present invention is described with reference to FIG. 7, where the lateral distance between the connector 16 provided adjacent to each distal end 19 of the support member 14 is accomplished via telescopic adjustment of the length of the support member 14. The shank 12 of the hitch 10 is inserted into the aperture leading into the hollow interior passage of the receiver secured to the underside of the vehicle adjacent to a tail section of the vehicle. A pair of apertures formed in opposite sides the shank 12 are aligned between a pair of similarly-sized apertures formed in the sides of the receiver, and a locking pin is inserted to extend through all four apertures. The communication between the locking pin and all four apertures releasably secures the hitch 10 to the vehicle. A secondary pin can be inserted through the portion of the locking pin that extends beyond the receiver to minimize the likelihood that the locking pin will be removed when said removal is not desired.

With the hitch 10 secured to the vehicle, the connectors 16 supported adjacent to the distal ends 19 of the support member 14, which in this example are ball-in-socket connectors 16, are positioned in a plane that is generally parallel to the ground on which the vehicle is resting. The lateral distance between the connectors 16 referred to herein is the distance in the connector plane that separates the connectors 16 from each other. Prior to positioning the connectors 16 of the hitch 10 adjacent to the trailer connectors 18, the lateral distance between the connectors 16 is maximized, or otherwise increased to a distance that is greater than a distance between the outermost portions of the male extensions 22 of the trailer connectors 18.

With the connectors 16 properly positioned, the vehicle can be backed into close proximity to the trailer such that the male extensions 22 of the trailer connector 18 are positioned between the connectors 16 of the hitch 10. In this position, each of the male extensions 22 is generally aligned along a common axis with the passage extending through the ball 28 of the respective connector 16 to which it is to be linked. If necessary, the ball 28 of each connector 16 can be rotated within its socket to achieve this proper alignment.

Once proper alignment of the male extensions 22 of each trailer connector 18 with the connectors 16 of the hitch 10 has been achieved, the trailer can be positioned such that one male extension 22 extends entirely through the passage formed in the ball 28 of one of the connectors 16. Communication between the locking pin 38 or other locking mechanism and the inner segment 36 is then terminated to permit relative movement of the inner segment 36 and the stationary segment 14b of the telescopically-adjustable portion of the support member 14. The length of the telescopically-adjustable portion of the support member 14 is adjusted to slide the passage of the ball 28 of the connector 16 provided to this distal end 19 of the support member 14 over the male extension 22 of the trailer connector 18. The locking pin 38 or other locking mechanism is then replaced to reestablish communication between the locking pin 38 and the inner segment 36 of the telescopic portion of the support member 14, thereby maintaining the relative position of said inner segment 36 and the stationary segment 14b. A secondary pin can optionally be inserted into an aperture 24 formed in the male extensions 22 of the trailer connector 18 to interfere with the removal of the male extensions 22 from the connectors 16. With communication between the connectors 16 and the trailer connectors 18 established to form linkages therebetween, the three-point trailer is hitched to the vehicle to be towed.

Another embodiment of the present invention in shown schematically in FIG. 6. Again, just as in previous embodiments, the lateral distance between the connectors 16 is adjustable to facilitate the establishment of linkages between those connectors 16 and trailer connectors 18. However, each connector 16 is supported adjacent to a distal end 19 of an arm 14a, 14b that is pivotally coupled to the shank 12 or other base member. The pivotal connection can be established with a hinge 50 that includes an interior passage defined by coaxially-aligned metal loops protruding from each arm 14a, 14b and at least one metal loop coupled to the shank 12. A metal hinge pin 52 extends through the interior passage to pivotally couple the arms 14a, 14b to the shank 12. A similar hinge 56 can optionally be provided adjacent to the distal end 19 of each arm 14a, 14b to pivotally couple the connectors 16 to the arms 14a, 14b. The pivotal connection between the connectors 16 and the arms 14a, 14b allows for adjustment of the connector position when establishing a linkage between the connectors 16 and the trailer connectors 18.

Just as with the previous embodiments, the connector 16 provided adjacent to the distal end 19 of each arm 14a, 14b can be independently selected from a female receptor such as a metal plate with an aperture formed therein, a ball-in-socket connector 16, and the like; and a male member such as a pin that is to extend through a female trailer connector 18, and the like. In any event, the sex of each trailer-connector 18 is to be the opposite of that of the respective connector 16 provided to the hitch 10 to facilitate cooperation and the formation of linkages therebetween. Regardless of the sex of each of the connectors 16 and the trailer connectors 18, each connector 16 is compatible with its respective trailer connector 18 to form a linkage therebetween.

In use, the embodiment of the hitch 10 shown in FIG. 6 can be secured within a receiver secured to the underside of the vehicle adjacent the vehicle's tail section in a manner similar to that described above with respect to the previous embodiments. The shank 12 of the hitch 10 is inserted into the aperture leading into the hollow interior passage of the receiver secured to the underside of the vehicle. A pair of apertures formed in opposite sides the shank 12 are aligned between a pair of similarly-sized apertures formed in opposite sides of the receiver, and a locking pin is inserted to extend through all four apertures. The communication between the locking pin and all four apertures releasably secures the hitch 10 to the vehicle. A secondary pin can be inserted through the portion of the locking pin that extends beyond the receiver to minimize the likelihood that the locking pin will be removed when said removal is not desired.

With the hitch 10 secured to the vehicle, the connectors 16 supported adjacent to the distal end 19 of each arm 14a, 14b, which in this example are ball-in-socket connectors 16, are positioned in a plane that is generally parallel to the ground on which the vehicle is resting. The lateral distance between the connectors 16 referred to in this discussion is the distance in the plane of connectors 16 that separates the connectors 16 from each other. Prior to positioning the connectors 16 of the hitch 10 adjacent to the trailer connectors 18, the lateral distance between the connectors 16 is maximized, or otherwise increased to a distance that is greater than a lateral distance between the outermost portions of the male extensions 22 of the trailer connectors 18. To maximize this lateral distance, the arms 14a, 14b are pivoted away from each other until they reach a terminal position.

With the connectors 16 properly positioned, the vehicle can be backed into close proximity to the trailer such that the male extensions 22 of the trailer connector 18 are positioned between the connectors 16 of the hitch 10. In this position, each of the male extensions 22 is generally aligned along a common axis with the passage extending through the ball 28 of the respective connector 16 to which it is to be linked. If necessary, the ball 28 of each connector 16 can be rotated within its socket to achieve this proper alignment.

Once proper alignment of the male extensions 22 of each trailer connector 18 with the connectors 16 of the hitch 10 has been achieved, one of the arms 14a, 14b can be pivotally adjusted to slide the passage in the ball 28 of one connector 16 over the male extension 22 of the corresponding trailer connector 18. A secondary pin 25 can be inserted to extend through a portion of the male extension 22 protruding beyond the ball 28 of the connector 16. Next, the other arm can be pivotally adjusted to position the other male extension 22 of the trailer connector 18 within the passage of the ball 28 provided to the other connector 16. Again, a secondary pin 25 can be inserted into an aperture 24 formed in the portion of the male extension 22 of the other trailer connector 18 that extends beyond the ball 28 to interfere with the removal of the other male extension 22 from the other connector 16. With communication between the connectors 16 and the trailer connectors 18 established to form linkages therebetween, the three-point trailer is hitched to the vehicle to be towed.

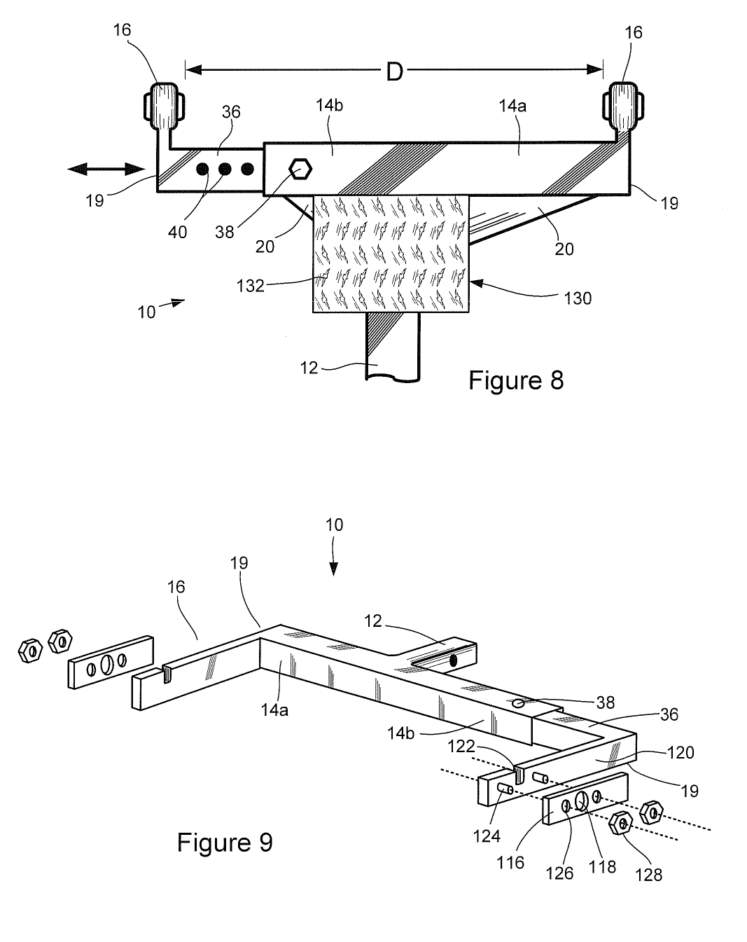

In addition to facilitating the releasable connection of the trailer connector 18 to the vehicle 82, the trailer hitch 10 can optionally include a step 130 as shown in FIG. 8 to support a person adjacent to the tail section of the vehicle 82. The step 130 can include a substantially planar steel or other suitably-rigid metal plate coupled to the support member 14, the shank 12, the gusset 20, or any combination thereof. A traction enhancing surface 132 such as a plurality of protrusions, diamond plating, grit paper, and the like can optionally be provided to a surface of the step 130 on which the person can stand. The traction enhancing surface 132 maximizes traction experienced by a person standing on the step 130 to minimize the likelihood of injury.

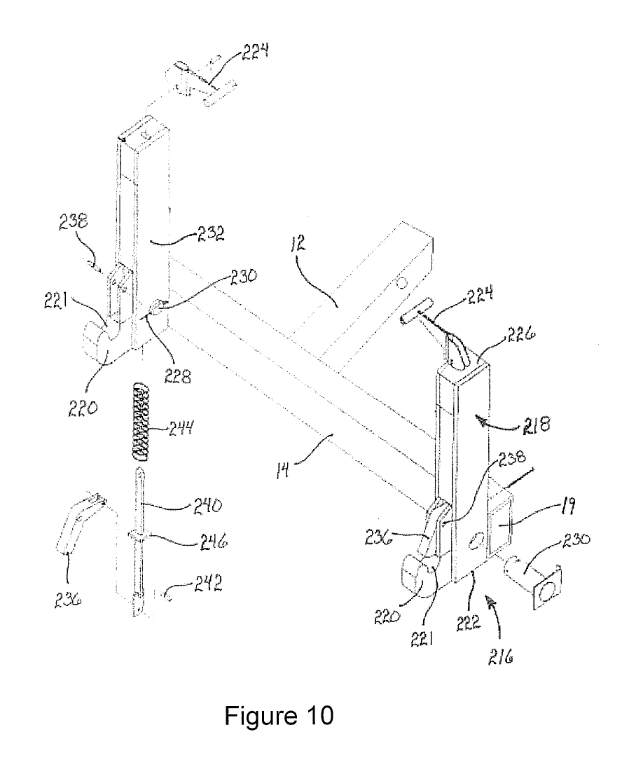

FIG. 10 illustrates yet another embodiment a quick-hitch connector 216 provided adjacent to each distal end 19 of the support member 14, which again, is coupled to or integrally formed with the shank 12. The connector 16 discussed above can optionally include the quick-hitch connector 216 for rapid coupling and decoupling of the trailer to the vehicle 82. The quick-hitch connector 216 includes an elongated housing 218 provided with a hook 220 adjacent to a lower end 222 and a pivotal handle 224 exposed adjacent to an upper end 226. The hook 220 can optionally be removed from the housing 218 by removing safety pin 228 from an inward portion of a hinge pin 230 that is extended through the housing 218 beyond an inward surface 232 of the housing 218. A channel 221 is defined by the hook 220 to receive the male extension 22 protruding from the trailer connector 18.

A latch 236 is pivotally coupled to the housing 218 to pivot about pin 238, and is adjustable between locked and release positions. A shaft 240 extends through an interior passage defined by the housing 218 between the handle 224 and a coupling 242 that couples the shaft 240 to the latch 236. A force imparted to adjust the position of the handle 224 is transmitted to the latch 236 through the coupling 242, thereby causing adjustment of the position of the latch 236. A spring 244 is compressed between the upper end of the housing 218 and a platform 246 extending outwardly from each shaft 240 to bias the handles 224 to their orientations when the latches 236 are in their locked position.

In use, the embodiment of the hitch 10 shown in FIG. 10 can be installed with the shank 12 disposed within the cavity 78 of the receiver 80 as described above. The vehicle 82, and accordingly, the hitch 10 is backed into position such that the channel 221 formed by the hook 220 is disposed approximately vertically beneath the male extensions 22 of the trailer connector 18. Each handle 224 is manually pivoted to a substantially vertical position, causing the latches 236 to pivot about the coupling 242 in a direction that exposes the channels 221 of the hooks 220 to the male extensions 22. The position in which the latches 236 are oriented when the channel 221 is exposed is referred to as the release position. The elevation of the trailer, or at least the trailer connector 18, can be lowered through the operation of a winch, hydraulics, or other mechanism provided to the trailer such that the male extensions 22 fall into the channels 221 and rest on the hooks 220. Once the male extensions 22 are so positioned, each handle 224 can once again be manually pivoted to a substantially horizontal orientation to allow each shaft 240 to fall and cause each latch 236 to pivot about coupling 242 towards their locked positions. With the latches 236 in their locked position, they conceal the channel 221 of each hook 220, along with a portion of the male extension 22 resting in each channel 221, thereby coupling the trailer to the vehicle 82 by preventing the male extensions 22 from exiting the channels 221.

Once the trailer has been relocated to the desired destination, the handle 224 can again be manually pivoted 224 to adjust the latches 236 to their release positions, in which they expose the male extensions 22 resting in the channels 221. With the male extensions 22 exposed, the elevation of the trailer, or at least the trailer connector 18, can be raised through the operation of a winch, hydraulics, or other mechanism provided to the trailer such that the male extensions 22 rise out of the channels 221.

Although the quick-hitch connectors 216 were shown in FIG. 10 as being provided adjacent to each distal end 19 of stationary portions of the support member, it is to be noted that one or both of the quick-hitch connectors 216 can optionally be provided adjacent to a distal end 19 of an adjustable inner segment 36 such as that described above. Such an embodiment is schematically illustrated in FIG. 11. As shown therein, the lateral distance D separating housing 218b from its counterpart is adjustable by telescopically inserting and removing the inner segment 36 relative to the support member 14 as described above. And similar to the preceding embodiments, the hitch 10 in FIG. 11 can be removably coupled to a vehicle 82 licensed to navigate public roadways by inserting at least a portion of the shank 12 into a recess 78 formed by a receiver 80. The shank 12 is removably secured within the recess 78 just as before by inserting a locking pin 250 (FIG. 7) through both an aperture 251 formed in the receiver 80 and an aperture 255 formed in the shank 12 that aligns with the aperture 251 in the receiver when the shank is inserted into the recess 78. According to such embodiments, the lateral distance D separating the quick-hitch connectors 216 can optionally be adjusted to accommodate trailers having male extensions 22 separated by a plurality of different lateral distances.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

What is claimed is:

1. A hitch for towing a trailer behind a vehicle, the hitch comprising:
a base member to be coupled to the vehicle;
a first arm coupled to the base and comprising a female receptor adjacent to a distal end thereof for receiving a first male connector of the trailer to couple the trailer to the vehicle; and
a second arm coupled to the base and comprising a female receptor adjacent to a distal end thereof for receiving a second male connector of the trailer to couple the trailer to the vehicle, wherein a lateral distance between the female receptor provided to the first arm and the female receptor provided to the second arm is selectively adjustable.

2. The hitch according to claim 1 further comprising a brace extending between the base member and at least one of the first and second arms.

3. The hitch according to claim 1, wherein the base member is an elongated metal shank receivable within a metallic receiver secured to the vehicle, wherein the metallic receiver has internal dimensions that approximate the external dimensions of the shank.

4. The hitch according to claim 3, wherein the shank has a generally rectangular cross-section.

5. The hitch according to claim 3 further comprising a locking pin sized to extend at least partially through the shank and the receiver while the shank is at least partially within the receiver.

6. The hitch according to claim 5, wherein the locking pin is to extend entirely through the shank and the receiver while the shank is at least partially within the receiver.

7. The hitch according to claim 6 further comprising a secondary pin that extends through the locking pin to interfere with removal of the locking pin from the shank and the receiver.

8. The hitch according to claim 1 further comprising a transverse member coupled to the base, wherein at least one of the first and second arms is coupled to the base by the transverse member.

9. The hitch according to claim 8, wherein at least one of the first and second arms coupled to the base by the transverse member is telescopically adjustable relative to the transverse member.

10. The hitch according to claim 9 further comprising an adjustment pin to extend at least partially through the transverse member and the at least one of the first and second arms that is telescopically adjustable to maintain a position of the at least one of the first and second arms relative to the transverse member.

11. The hitch according to claim 1, wherein the first and second arms are formed as a transverse member that extends away from the base in opposite directions.

12. The hitch according to claim 1, wherein the female receptor provided to the first and second arms is a ball-in-socket coupling.

13. The hitch according to claim 1, wherein at least one of the first and second arms is pivotally coupled to the base to travel in a plane generally parallel to the ground when the hitch is secured to the vehicle.

14. A hitch for towing a trailer behind a vehicle licensed to navigate public roadways, the hitch comprising:
a base member to be coupled adjacent to a tail section of the vehicle;
a first support member coupled to the base member and extending outwardly in a direction generally away from the base member;
a first connector provided adjacent to a distal end of the support member that is cooperable with a first trailer connector to establish a linkage between the first connector and the first trailer connector;
a second support member coupled to the base member and extending outwardly in a direction generally away from the base member; and
a second connector provided adjacent to a distal end of the second support member that is cooperable with a second trailer connector to establish a linkage between the second connector and the second trailer connector.

15. The hitch according to claim 14, wherein a lateral distance between the first connector provided to the first and the second connector receptor provided to the first arm and the female receptor provided to the second arm is selectively adjustable.

16. The hitch according to claim 14, wherein at least one of the first and second support members is telescopically extendable in the direction generally away from the base member.

17. The hitch according to claim 16 further comprising a locking pin for maintaining a position of the connector provided to the at least one of the first and second support members that is telescopically adjustable relative to the base.

18. The hitch according to claim 14, wherein at least one of the first and second support members is pivotally coupled to the base member to facilitate adjustment of a lateral distance between the first and second connectors.

19. The hitch according to claim 18 further comprising a restraint for establishing a maximum distance between the first and second connectors.

20. The hitch according to claim 19, wherein the restraint includes at least one of a chain and a metallic plate.
